(19) United States
(12) Patent Application Publication
(10) Pub. No.: US 2013/0315688 A1
(43) Pub. Date: Nov. 28, 2013

(54) Nut Holding Structure For Solar Power Junction Box

(71) Applicant: T-CONN PRECISION CORPORATION, New Taipei City (TW)

(72) Inventor: CHANG WEI, New Taipei City (TW)

(73) Assignee: T-CONN PRECISION CORPORATION, New Taipei City (TW)

(21) Appl. No.: 13/654,429

(22) Filed: Oct. 18, 2012

(30) Foreign Application Priority Data
May 25, 2012 (TW) 101209935

(51) Int. Cl. F16B 39/282

(52) U.S. Cl. CPC F16B 39/282
USPC 411/144

(57) ABSTRACT

A nut holding structure for a solar power junction is disclosed. The nut includes screw-connected base having one end disposed on junction box and other end has a holding assembly and a threaded segment. The nut is screw-coupled with the screw-connected base, in which the outer edge is being convexly disposed with at least one holding hook. The holding hook and the holding assembly mutually prop up and couple the nut, after the nut being is completely screwed on to the threaded segment to prevent the nut from slipping off and thereby improving assembling and increasing the reliability of connection between the nut and the screw-connected base.

### FIELD OF THE INVENTION

The present invention relates to a solar power junction box, and more particularly, to a nut holding structure for a solar power junction box.

### BACKGROUND OF THE INVENTION

As the concept on earth environmental protection is developing, solar power with permanence, non-contamination and safety properties has become an alternative energy of environmental protection for every county seeking a green earth, practically leading to energy saving and carbon reduction. The electricity generation principle of the solar power is a photovoltaic effect that the sunlight shines on the photoelectric elements and silicon in the solar battery absorbs the sunlight with a wave length ranging 0.4 μm˜1.1 μm, and produces electron holes and electrons through P-type semiconductor and N-type semiconductor. Voltage fall is proceeded when the electron holes and the electrons are separated. Through the transmission of the conducting wire, the electricity generation is completed. The electricity of the solar power is outputted through a junction box to a transformer or a control unit. After special treatments, the electricity can be used by power apparatus.

However, when the conventional solar power junction box is installed, the conducting wire is often damaged due to damp or external destruction. Therefore, for installing conducting wire to the junction box during the process of power distribution, each conducting wire along its conduit extends outward to transmit electricity in many directions. Furthermore, the conduit is often directly connected to the junction box without a securing device. After wire connection, the nut of the junction box often easily slips off from the screw-connected base. This adversely affects future maintenance and operational safety.

### SUMMARY OF THE INVENTION

In view of this, the present invention provides a nut holding structure for the solar power junction box. After the nut is completely screwed into the screw-connected base, the holding hook and the holding assembly prop up and couple with each other and may prevent the screw-connected object from slipping off and promote assembly convenience and enhance connection reliability.

According to an embodiment of the present invention, a nut holding structure for solar power junction box comprises a screw-connected base and a nut. The screw-connected base comprises a base body at one end thereof and a holding assembly and a threaded segment at the other end thereof. The nut can be screw-coupled with the screw-connected base. The outer edge of the nut is convexly disposed with at least one holding hook. The holding hook and the holding assembly are mutually propped up.

According to an embodiment of the present invention, the outer edge portion of the nut is convexly disposed with at least one holding hook. The holding hook can prop up and couple with the holding assembly after the holding hook is screwed to the threaded segment.

According to an embodiment of the present invention, one end of the threaded segment comprises a holding assembly capable of propping and coupling with the holding hook after the nut is screwed in.

According to an embodiment of the present invention, the holding hook and the holding assembly securely couple to each other when the nut is completely screwed on to the threaded segment.

The nut and the screw-connected base of the present invention are disposed with at least one holding hook and one holding assembly respectively and requires no tool for installation. When the nut is completely screwed to the screw-connected base, the nut and the screw-connected base securely couple to each other to prevent the possibility of the nut from slipping off after being screwed. The structure of the nut according to the present invention promotes a good applicability, and increases the reliability of connection.

### BRIEF DESCRIPTION OF THE DRAWINGS

FIG. 1A is a perspective view of the present invention.

FIG. 1B is a partially enlarged schematic drawing of FIG. 1A.

FIG. 2 is a partially enlarged schematic drawing after the nut is screwed to the screw-connected base of the present invention.

FIG. 3A is a perspective view illustrating before the nut is screwed to the screw-connected base of the present invention.

FIG. 3B is a schematic drawing illustrating after the nut is screwed on to the screw-connected base of the present invention.

FIG. 4A is a frontal sectional view illustrating before the nut is screwed on to the screw-connected base of the present invention.

FIG. 4B is a frontal sectional view illustrating after the nut is screwed on to the screw-connected base of the present invention.

FIG. 5A is a frontal view of the present invention.

FIG. 5B is a partially enlarged drawing of FIG. 5A.

FIG. 5C is a left side view of the present invention.

FIG. 5D is a frontal sectional view of the present invention.

FIG. 6A is a perspective view of the present invention applied to the nut of the solar power PV connector before the nut is screwed to the screw-connected base.

FIG. 6B is a perspective view of the present invention applied to the nut of the solar power PV connector after the nut is screwed to the screw-connected base.

FIG. 6C is a partially enlarged schematic drawing of FIG. 6A.

FIG. 6D is a partially enlarged schematic drawing of FIG. 6B.

FIG. 7A is a frontal view of the present invention applied to the nut of the solar power PV connector after the nut is screwed to the screw-connected base.

FIG. 7B is a top sectional view of the present invention applied to the solar power PV connector.

FIG. 7C is a frontal sectional view of the present invention applied to the nut of the solar power PV connector after the nut is screwed to the screw-connected base.

### DESCRIPTION OF THE PREFERRED EMBODIMENTS

In order to let the present invention be completely understood on its objective, characters and effects, a detailed description is made through following preferred embodiment and the drawings.

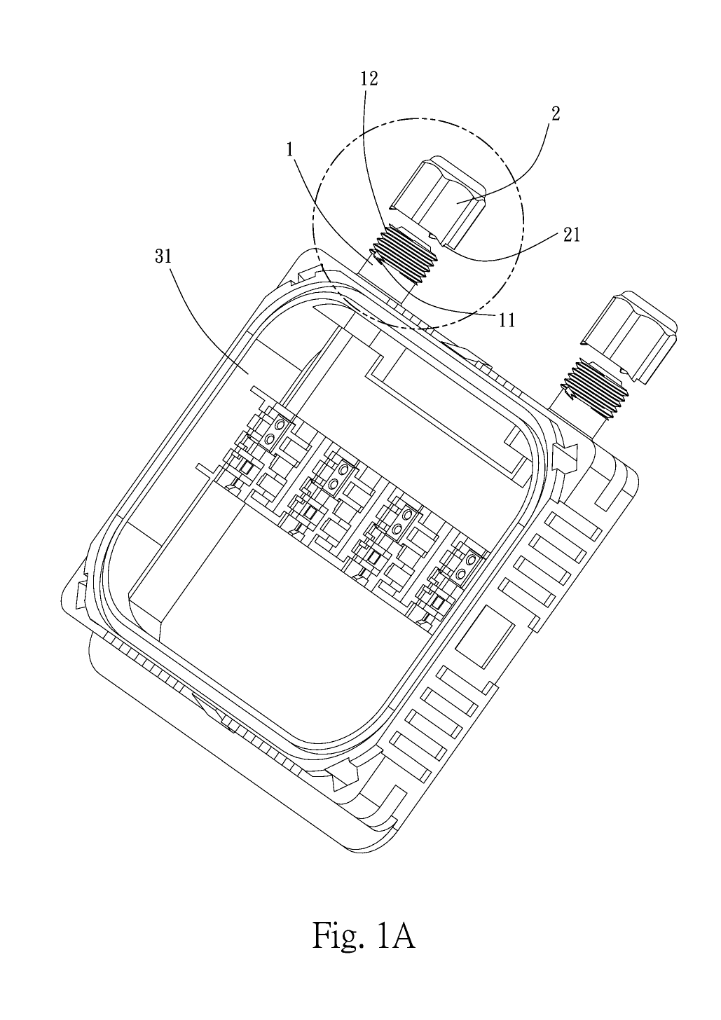

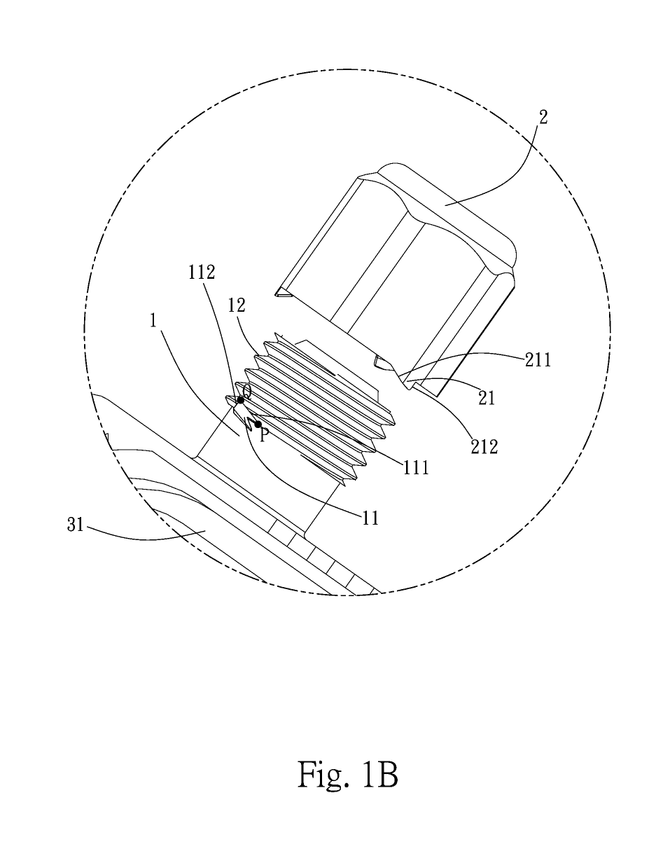

FIG. 1A is a perspective view of the present invention. As illustrated, the nut holding structure of the solar power junction box comprises a screw-connected base 1 and a nut 2. One end of the screw-connected base 1 is disposed on the junction box 31 while the other end comprises a holding assembly 11 and a threaded segment 12. The holding assembly 11 is disposed at an end portion of the threaded segment 12. The nut 2 is screw-coupled with the screw-connected base 1. The outer edge of the nut 2 comprises at least one holding hook 21. The holding hook 21 and the holding assembly 11 mutually prop up and couple with each other.

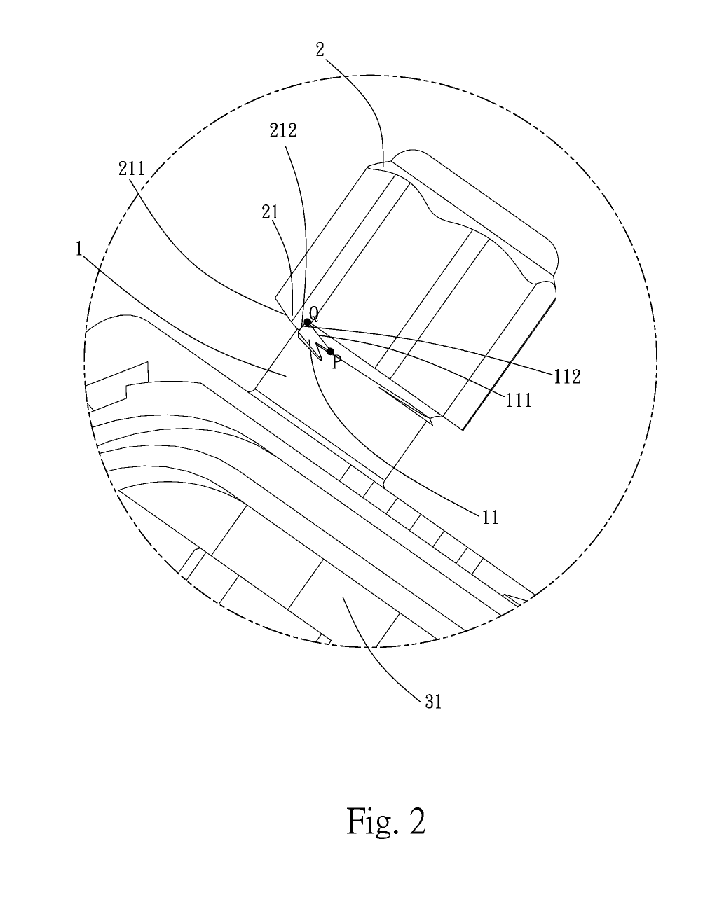

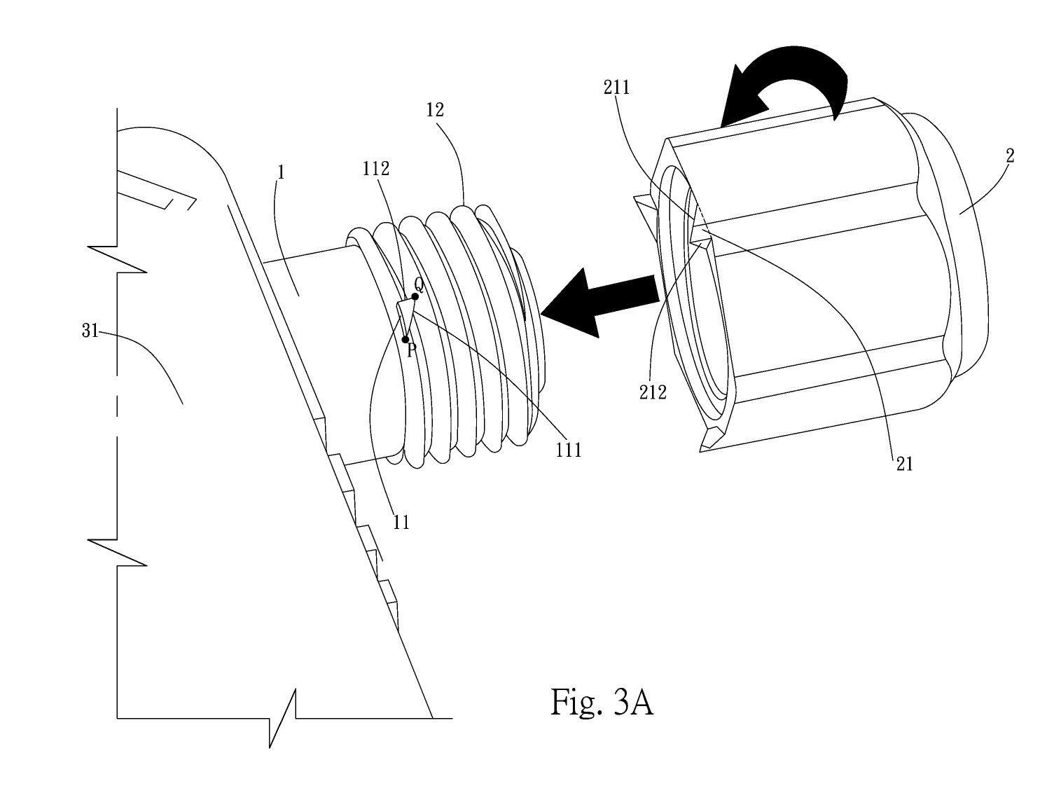

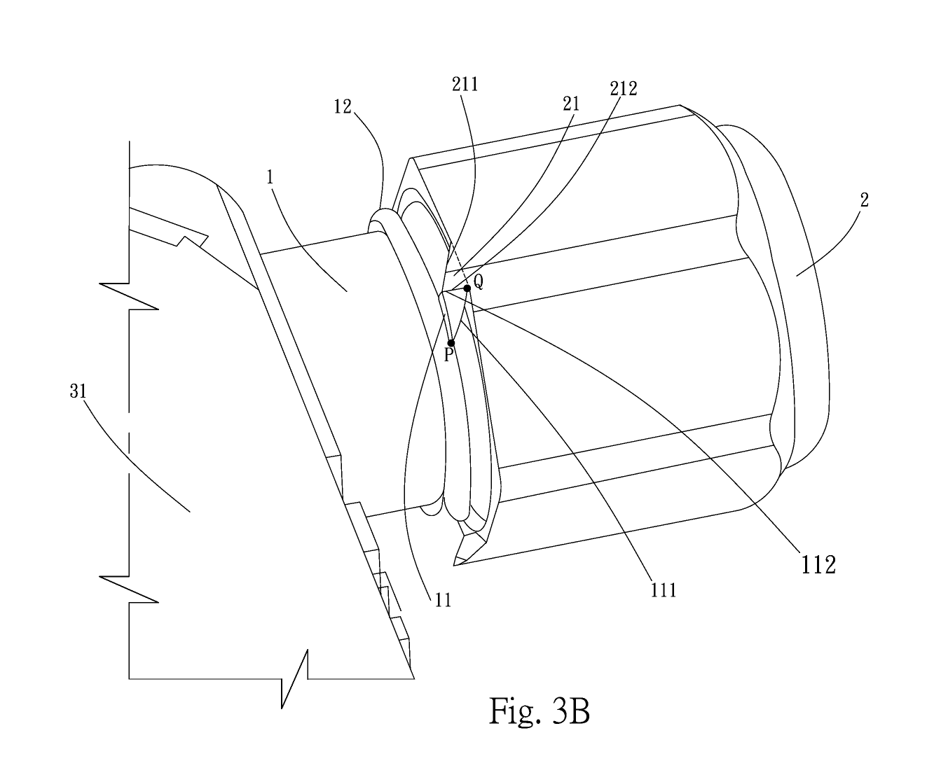

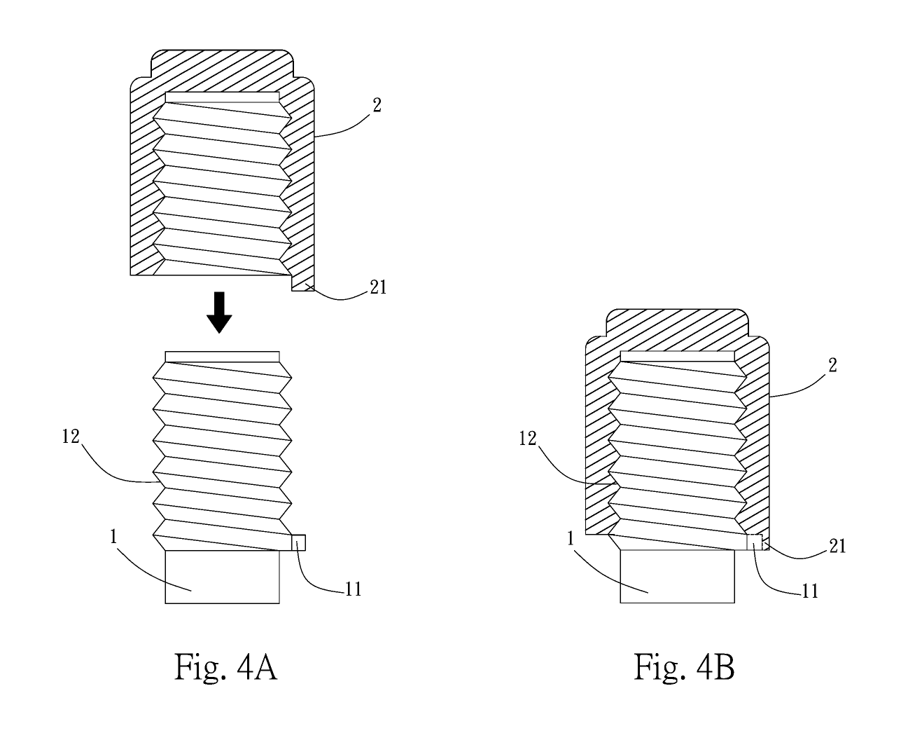

FIGS. 1B, 2, 3A, 3B, 4A and 4B illustrate partially enlarged schematic drawings of FIG. 1A of the present invention to show the partially enlarged schematic drawing of the present invention after the nut is screwed on to the screw-connected base, the 3-D schematic drawings before and after the nut is screwed on to the screw-connected base, as well as the frontal sectional drawings before and after the nut is screwed on to the screw-connected base. As illustrated above, when the nut 2 of the present invention is completely screwed on to the threaded segment 12, the holding hook 21 convexly disposed on the nut 2 couples with the holding assembly 11 of the screw-connected base 1 to prevent the nut 2 from slipping off after being screwed, which is illustrated in FIGS. 1B, 2, 3A and 3B. After the nut 2 of the present invention is screwed on to the threaded segment 12 up to the holding hook ramp 211 and pass through point P of the holding assembly ramp 111, the holding hook ramp 211 and the holding assembly ramp 111 begin to prop each other up. After the nut is screwed even further to pass through point Q of the holding assembly ramp 111, the vertical wall 212 of the holding hook will be vertically blocked at the vertical wall of holding assembly 112. The both vertical walls are mutually propped up to form a propping and block-coupling status. Referring to FIGS. 1B and 3A, the holding hook 21 convexly disposed on the nut 2 is a pyramid-shaped block. The holding assembly 11 of the screw-connected base 1 is a V-shaped block, a pyramid-shaped block or a pyramid-shaped slab-like body. The holding assembly 11 may also be in other geometric shape.

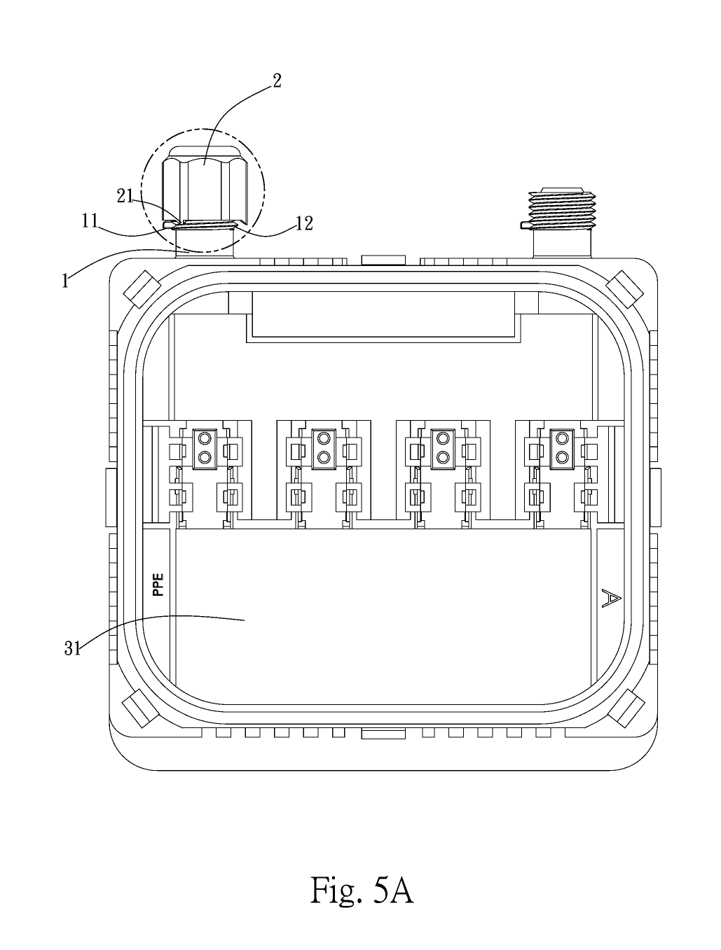

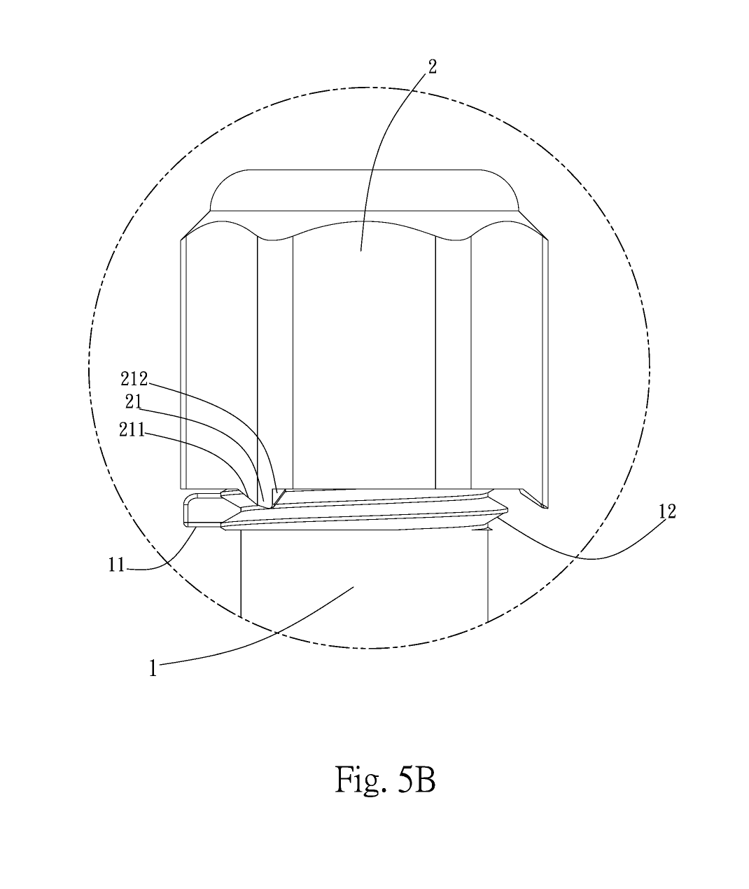

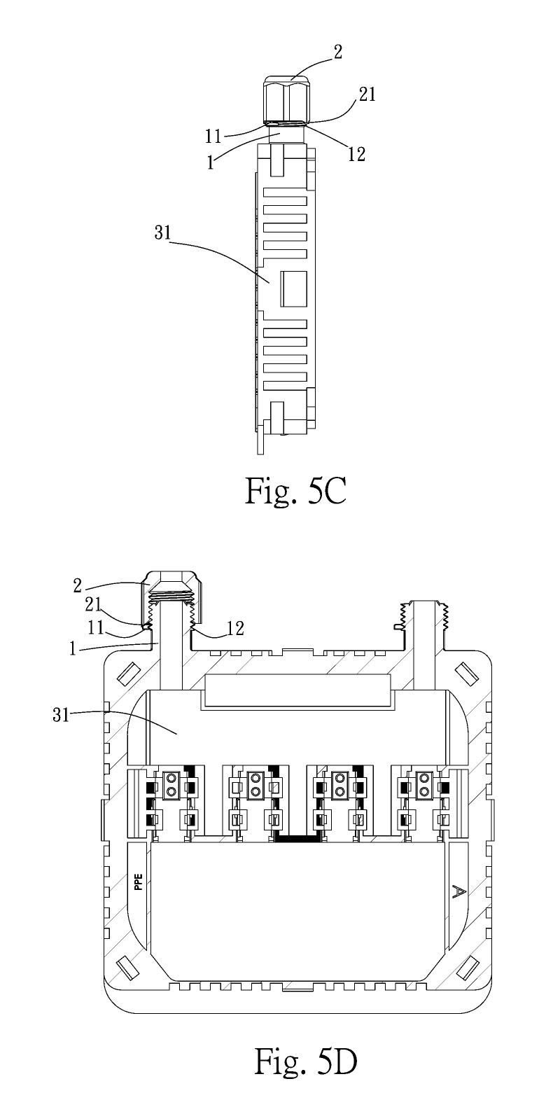

FIGS. 5A, 5B, 5C and 5D illustrate a frontal view, a partially enlarged schematic drawing, a left side view and a frontal sectional view of the present invention respectively. As illustrated in figures, when the nut 2 of the present invention is screwed on to the threaded segment 12 up to the holding hook ramp 211 of the nut 2 and pass through the annular edge of the holding assembly 11, the holding hook ramp 211 and the annular edge of the holding assembly 11 begin to prop each other up. After the nut is further screwed to pass through the annular edge of the holding assembly 11, the vertical wall 212 of the holding hook will vertically block-connect the annular edge of the holding assembly 11 to form an action of mutual prop-blocking. Referring to FIG. 5B, the holding hook 21 convexly disposed on the nut 2 comprises a pyramid-shaped block. The holding assembly 11 of the screw-connected base 1 comprises a U-shaped annular block.

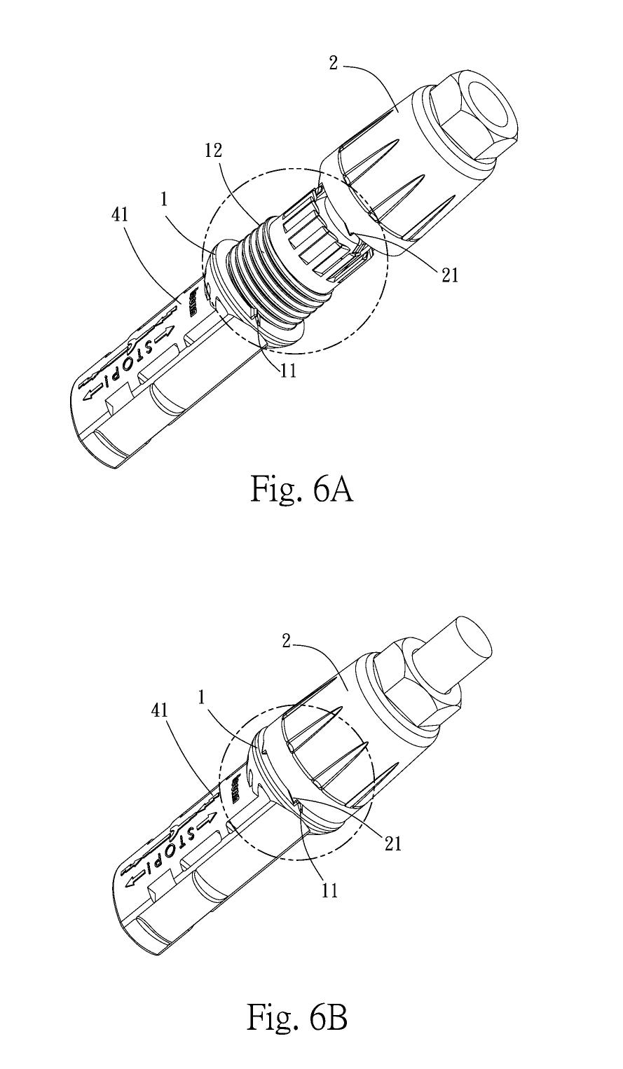

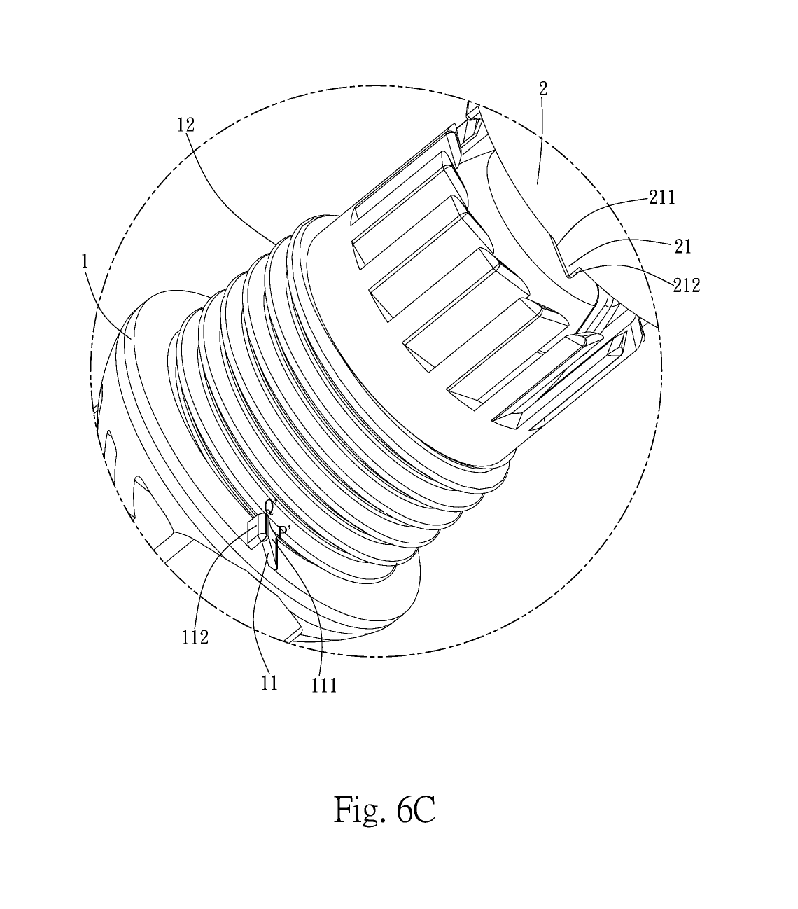

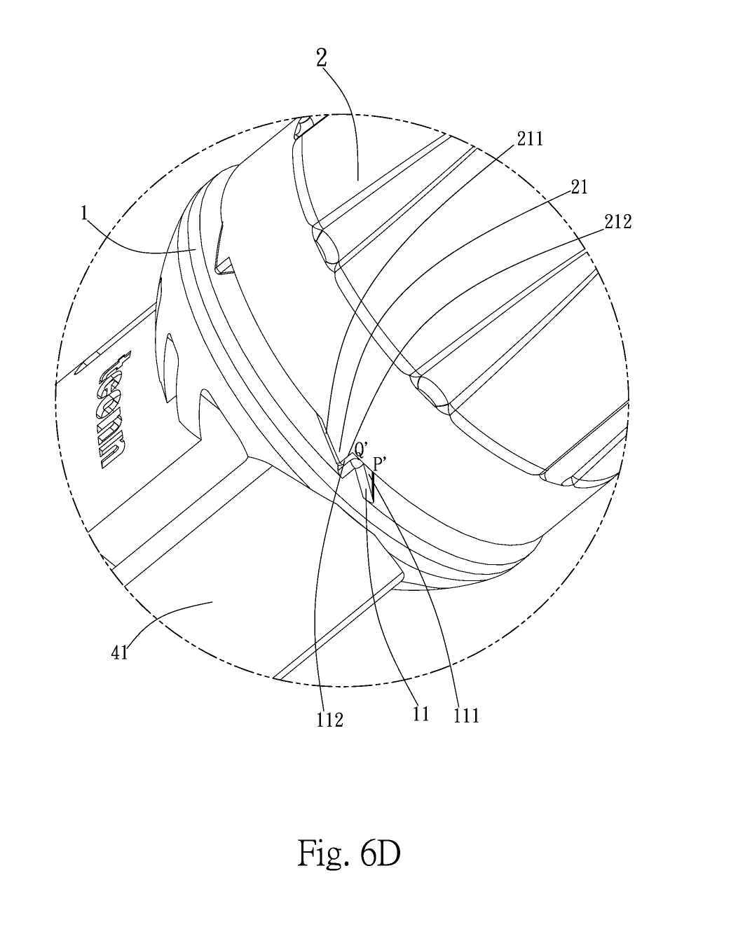

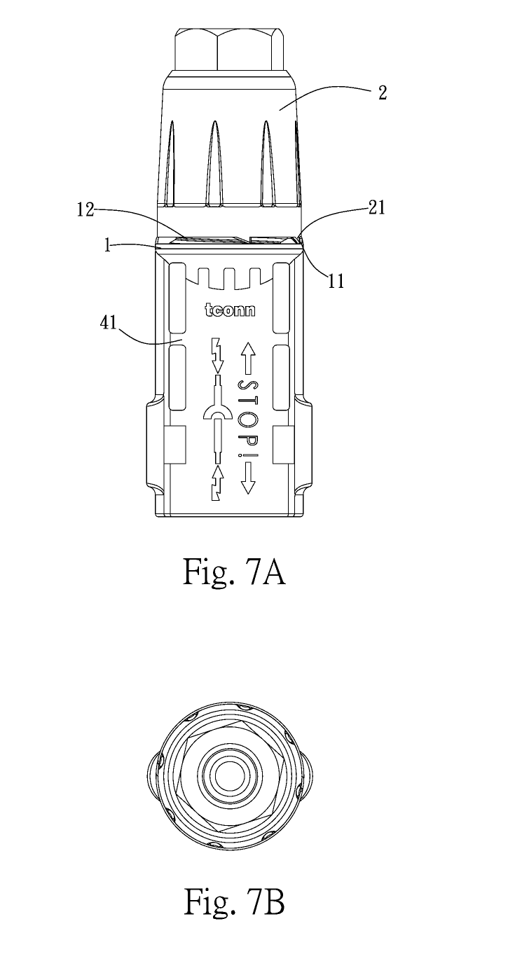

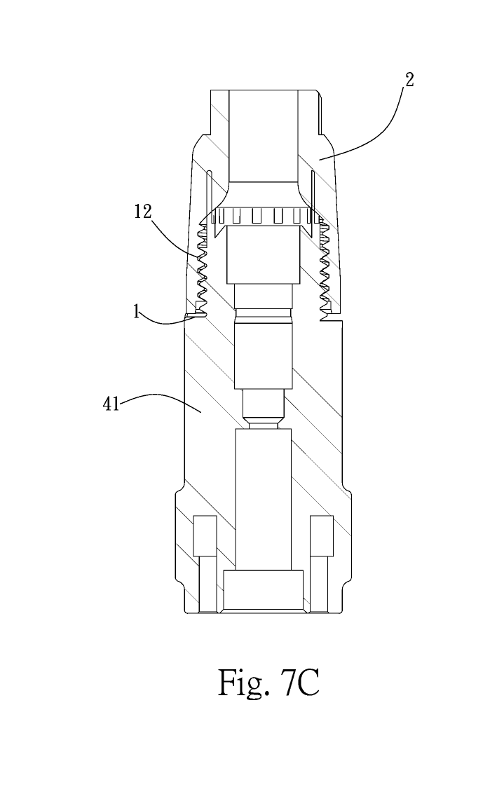

FIGS. 6A/B/C/D and 7A/B/C illustrate partially enlarged schematic drawings and 3-D drawings of the outer view of the present invention applied to the nut of the solar power PV connector 41 before and after the nut is screwed to the screw-connected base, and also a frontal view, a top sectional view and a front sectional view of the present invention applied to the nut of the solar power PV connector after the nut is screwed to the screw-connected base. The present invention can be applied to the nut holding structure of the solar power PV connector 41 as well. As illustrated in figures, a nut holding structure of solar power PV connector 41 comprises at least a screw-connected base 1 whose one end portion has a base body while the other end portion has a holding assembly 11 and a threaded segment 12, and a nut 2 to be screw-coupled with the screw-connected base 1. The outside outer edge portion of the nut is convexly disposed with at least one holding hook 21 which is can be mutually propped up and block-coupled with and propped up by the holding assembly 11. When the nut 2 is completely screwed on to the threaded segment 12, the holding hook 21 and the holding assembly 11 form a propping and blocking action, wherein the propping and block-connecting process is illustrated in FIGS. 6C/D. When the nut 2 of the present invention is screwed on to the threaded segment 12, and further screwed and when to the holding hook ramp 211 of the nut 2 to passes through point P′ of the holding assembly ramp 111, the holding hook ramp 211 and the holding assembly ramp 111 begin to be mutually propped up. After the nut is screwed further to and pass through point Q′ of the holding assembly ramp 111, the vertical wall 212 of the holding hook will vertically block the vertical wall 112 of the holding assembly, and be mutually propped at the same time to form a prop coupling. Referring to FIG. 6C, the holding hook 21 convexly disposed on the nut 2 comprises a pyramid-shaped block. The holding assembly 11 of the screw-connected base 1 comprises a pyramid-shaped slab-like body.

To sum up, according to the present invention can the holding hook of the solar power junction box and the holding assemblies disposed on the nut and the screw-connected base respectively, when the nut is completely screwed to the threaded segment, the holding hook and the holding assembly will mutually prop up and coupling to each other to prevent the nut from slipping off. Thus, the components are simple. The assembling is easy. The stability of the coupling between the screw-connected base and the nut is enhanced.

While the invention has been described by means of specific embodiments, numerous modifications and variations could be made thereto by those skilled in the art without departing from the scope and spirit of the invention set forth in the claims.

What is claimed is:

1. A nut holding structure of the solar power junction box comprising:
a screw-connected base whose one end is installed to the junction box while the other end is disposed with a holding assembly and a threaded segment; and
a nut which is screw-coupled with the screw-connected base, and whose outer edge is convexly disposed with at least one holding hook to be mutually propped up and coupled with the holding assembly;
wherein, when the nut is completely screwed on to the threaded segment, the holding hook and the holding assembly prop up the nut.

2. A nut holding structure of the solar power PV connector comprising:
a screw-connected base whose one end has a base body while the other end is disposed with a holding assembly and a threaded segment; and
a nut which is screw-coupled with the screw-connected base, and whose outer edge is disposed with at least one holding hook to be mutually prop-blocked with the holding assembly;
wherein, when the nut is completely screwed to the threaded segment, the holding hook and the holding assembly prop up the nut.

3. The nut holding structure of the solar power junction box as claimed in claim 1, wherein the holding assembly of the screw-connected base comprises a V-shaped block.

4. The nut holding structure of the solar power junction box as claimed in claim 1, wherein the holding assembly of the screw-connected base comprises a pyramid-shaped block.

5. The nut holding structure of the solar power junction box as claimed in claim 1, wherein the holding assembly of the screw-connected base comprises a U-shaped annular block.

6. The nut holding structure of the solar power junction box as claimed in claim 1, wherein the holding assembly of the screw-connected base comprises a pyramid-shaped slab-like body.

7. The nut holding structure of the solar power junction box as claimed in claim 1, wherein the holding hook convexly disposed on the nut comprises a pyramid-shaped block.

8. The nut holding structure of the solar power junction box as claimed in claim 3, 4 or 6, wherein the holding assembly is disposed with a holding assembly ramp and a vertical wall of holding assembly while the holding hook is disposed with a holding hook ramp and a vertical wall of holding hook.
